(19) United States
(12) Patent Application Publication
(10) Pub. No.: US 2014/0202127 A1
(43) Pub. Date: Jul. 24, 2014

(54) Front attachment for harvesting corn

(71) Applicant: CLAAS SELBSTFAHRENDE ERNTEMASCHINEN GMBH, HARSEWINKEL (DE)

(72) Inventors: Thomas Tilly, Warendorf (DE); Thomas Dennis Engler, Germaringen (DE); Bernd Albinger, Rheda-wiedenbrueck (DE); Thomas Zegota, Harsewinkel (DE)

(73) Assignee: CLAAS SELBSTFAHRENDE ERNTEMASCHINEN GMBH, HARSEWINKEL (DE)

(21) Appl. No.: 14/157,623

(22) Filed: Jan. 17, 2014

(30) Foreign Application Priority Data
Jan. 18, 2013 (DE) 10 2013 100 495.4

(51) Int. Cl. A01D 69/08; A01D 45/02

(52) U.S. Cl. CPC A01D 69/08; A01D 45/02
USPC 56/10.3

(57) ABSTRACT

A front attachment for harvesting corn for a self-propelled combine harvester includes a snapping unit for separating the corn cobs from the remaining components of the corn plant. The snapping unit has snapping rollers that rotate in opposite directions. An overload clutch is disposed within a drive train of the snapping unit. A drive system is optimized in that an overload clutch is directly assigned to each of the snapping rollers.

### CROSS-REFERENCE TO A RELATED APPLICATION

The invention described and claimed hereinbelow is also described in German Priority Document DE 10 2013 100495.4, filed on Jan. 18, 2013. The German Priority Document, the subject matter of which is incorporated herein by reference, provides the basis for a claim of priority of invention under 35 U.S.C. 119(a)-(d).

### BACKGROUND OF THE INVENTION

The invention relates to a front attachment for harvesting corn for a self-propelled harvesting machine that comprises a snapping unit for separating the corn cobs from the remaining components of the corn plant. The snapping unit has snapping rollers, which rotate in opposite directions and, an overload clutch disposed within the snapping unit drive train.

Corn is generally cultivated in rows, wherein sowing is carried out by sowing individual seeds. The corn plant substantially comprises a corn stalk, corn leaves having a length of up to one meter. Fruits are in the form of corn cobs enclosed by husks. Corn plants that have gone to seed can reach a height of up to three meters.

There are two main types of corn harvesting, namely harvesting fodder corn or biomass using a combine harvester and, harvesting grain corn using a combine harvester equipped with an appropriate front attachment. The forage harvester fragmentizes the entire corn plant, including the corn kernels, to permit the subsequent use thereof as fodder, in the form of corn for silage. In this fragmentized form, the corn plant can also be supplied as biomass to biogas plants. The forage harvesters used to harvest the corn plants process the entire corn plant and therefore the fruit, i.e., the corn cobs comprising the corn kernels, do not need to be separated from the remaining plant components.

In contrast, in order to harvest grain corn using a combine harvester, the header thereof (which is used to harvest grain), is replaced by a front attachment for harvesting corn. Such a corn front attachment comprises a plurality of harvesting devices, namely intake conveyor mechanisms, which grasp the particular corn stalk and guide the corn stalk within a guide track, via a picking device. Such structure and operation ensures controlled intake of the entire corn plant and removal of the corn cob from the corn stalk. A cross conveyor draws the corn cobs separated from the individual corn stalks to the center of the front attachment, in the trough thereof, and transfers the corn cobs to a feed rake.

This feed rake, however, is a component of the combine harvester. That is, when the front harvesting attachment is coupled to the combine harvester, the front harvesting attachment is connected to the feed rake, which feeds the corn cobs to a threshing mechanism of the combine harvester during the harvesting operation. The front attachment comprises a plurality of snapping units that depends on the working width. The snapping units comprise snapping rollers that work together in pairs, wherein one such snapping unit is typically assigned to each of the aforementioned intake conveyor mechanisms. The snapping rollers, which are profiled on the outer jacket surface thereof, can be oriented either in the harvesting direction or transversely thereto.

At least one of the snapping rollers of the particular pair of snapping rollers accommodates a header auger on the front side thereof. The header auger conveys the corn stalks into the region of the profiled snapping rollers. A snapping gap formed by snapping plates is assigned to every pair of snapping rollers. The snapping gap is disposed in a vertical plane extending between the two snapping rollers. During the snapping procedure, the corn stalk is drawn over the rotating snapping rollers, through the snapping gap in the direction toward the ground in order that the corn cob is wiped off the corn stalk at the snapping plates, that is, the corn cob is separated from the corn stalk.

During this motion, the corn stalk is cut off close to the ground, chopped up and deposited onto the around by means of optionally provided chopping knives of a o chopping mechanism. The chopping knives are disposed on a vertically extending knife shaft. It also is possible to provide a chopping mechanism in the form of a mulching device or a free-swinging mower, disposed underneath the feed rake of the combine harvester or, to mount the chopping mechanism on the rear panel of the front attachment.

The chopping device ensures complete fragmentation of the corn straw, which comprises leaf portions of the corn plants and the corn stalks, so that the corn straw is distributed more uniformly over the ground and can be worked completely into the ground in subsequent soil management. Working the corn straw completely into the ground and, mixing the corn straw uniformly with the ground in order to promote the rotting of the corn straw is of considerable importance for the prevention of pest contamination, such as contamination by fusarioses or Pyrausta nubilalis.

Overload states can occur on the snapping unit during the corn harvest, however. These overload states are caused primarily by the front attachment picking no a quantity of crop that is too great, or by foreign objects being drawn onto the front attachment and entering the space between the snapping rollers and inducing an increase in torque thereon. An overload protection feature in the form of a shearing component or an overload clutch is therefore disposed in the drive train of the front attachment. This overload protection feature interrupts the drive of the snapping unit or the entire front attachment when a maximum torque is exceeded.

A front attachment for harvesting corn of the type set forth in the preamble of claim 1 is known from DE 103 29 409 A1. This front attachment, which is referred to in this document as an intake conveyor and snapping unit, is provided with snapping rollers. The snapping rollers extend via the axial extension thereof in the direction of the crop flow. An intake conveyor element, which comprises radially extending fingers distributed around the circumference thereof, is disposed next to the pair of snapping rollers. In addition, a stalk chopper, which is provided with radially extending knives and chops up the harvested corn stalks, is disposed underneath the pair of snapping rollers.

A drive train of the front attachment comprises a main drive shaft, which is driven by the drive system of the harvesting machine, extends transversely to the front harvesting attachment and drives the two snapping rollers and the stalk chopper by means of a bevel gear. An overload clutch for the drive train of the two snapping rollers and an overload clutch for the drive train of the stalk chopper are disposed next to one another on a drive shaft extending from the bevel gear, within a gearbox housing, which accommodates the bevel gear. As a result, the overload clutches are disposed within the gearbox housing in a space-saving manner and, run in a jointly used oil bath thereof.

Furthermore, document FR 2 805 963 A1 makes known a front attachment for harvesting corn, including snapping rollers extending longitudinally in the harvesting direction that are likewise driven via a bevel gear disposed in a gearbox housing. The bevel gear in this case comprises a double-bevel gear, which is disposed on a main drive shaft and is integrated in an overload clutch. Bevel gears of the two snapping rollers are engaged with the bevel-gear tooth structures of the double-bevel gear.

### SUMMARY OF THE INVENTION

The present invention overcomes the shortcomings of known arts, such as those mentioned above.

To that end, the present invention provides a drive system for a front attachment of a self-propelled harvesting machine, for harvesting corn, that includes an overload clutch for the snapping unit that is disposed in an optimal manner in terms of the function thereof and the installation space that is required.

In an embodiment, the invention provides a front attachment for harvesting corn for a self-propelled harvesting machine comprising a snapping unit for separating the corn cobs from the remaining components of the corn plant, where the snapping unit is configured with snapping rollers, which rotate in opposite directions. An overload clutch is disposed within a drive train of the snapping unit. The overload clutch is directly assigned to each snapping gap. Due to the assignment of individual overload clutches to the snapping rollers and, therefore, the separate monitoring of the torque occurring at the individual snapping rollers, the overload torque monitored at the overload clutch can be reduced for the drive train.

It is therefore possible to markedly reduce the torques occurring at the components of the snapping rollers and to markedly reduce the resultant forces. The dimensions of the components of the snapping unit and the drive elements thereof can therefore be optimized such that gearwheels, shafts, housing, and connecting elements can be reduced in size. These size reductions result in a significant reduction in the weight, costs, and required installation space. In addition, the overload elements of the overload clutch can be designed having a smaller diameter, thereby reducing the wear-relevant sliding speeds.

By contrast, according to DE 103 29 409 A1 and FR 2 805 963 A1, the respective overload clutches are disposed such that, by means thereof, both snapping rollers are jointly protected against a maximum torque being exceeded. As a result, however, only the sum of the torques occurring at the two snapping rollers can be monitored. Due to a safeguarding of the snapping rollers, in pairs, which is already known from these documents, the guarding torque must be relatively high, in accordance with the overall power uptake. As a result, the individual components must always be designed for a relatively high overall torque.

In a further embodiment of the invention, the overload clutch is disposed within the drive shaft accommodating the particular snapping roller. In this case, the particular overload clutch is advantageously disposed outside of the gearbox housing, thereby making it possible to reduce the structural dimensions of the gearbox housing and ensuring that the material worn off the overload clutch does not contaminate the gearbox oil contained in the gearbox housing. Instead, the individual overload clutches can be designed as separately grease-lubricated assemblies. Repair and maintenance work can be carried out much more easily than if the overload clutches were disposed, together with the remaining components, within the gearbox housing.

Alternatively, the respective overload clutch can be disposed within the axial extension of the snapping roller.

As a result, the corresponding overload clutch can be integrated into the interior of the snapping roller, thereby saving installation space. The corresponding overload clutch is thereby disposed between the corresponding shaft, which extends into the interior of the snapping roller, and the snapping roller.

In another embodiment, the snapping rollers comprise a hollow cylindrical roller body. In this case, a first coupling surface of the overload clutch is formed on an inner jacket surface of the roller body. An outer jacket surface of the drive shaft, which extends concentrically through the roller body, along the entire axial length thereof, is used as the second coupling surface. Coupling elements, which are elastic or preloaded via springs, are disposed between these two coupling surfaces. A relatively large installation space for the integration of the overload clutch is therefore available in the interior of the respective snapping roller. Such large installation space makes it possible to select the number of coupling elements such that only a small amount of wear occurs thereon during operation of the front attachment.

In one or more embodiments, the inner jacket surface is guided with frictional engagement relative to the outer jacket surface, wherein preloaded coupling elements are disposed between these surfaces. In this case, the overload clutch is designed as a friction clutch, wherein driving elements are formed on one of the two components and accommodate coupling elements designed as friction elements. These friction elements are guided under preload on the opposite surface, i.e. the inner jacket surface or the eater jacket surface.

Alternatively, the inner jacket surface and/or the outer jacket surface, together with the coupling elements, form a non-positive coupling system. This can be the function of a star ratchet, for example, in the case of which the coupling elements are guided on one of the components in a form-fit manner and are supported by compression springs. The ends of these coupling elements lie in detent recesses and are moved out of the detent recess via a ramp when a maximum torque is exceeded.

### BRIEF DESCRIPTION OF THE DRAWINGS

Further features and advantages of the invention will become apparent from the description of embodiments that follows, with reference to the attached figures, wherein:

FIG. 1 presents partial top view of a unit of a front attachment constructed according to the invention, in which intake conveyor elements, snapping rollers, and a cross conveyor are disposed;

FIG. 2 presents a side view of a corresponding system constructed according to the invention that highlights the arrangement of the snapping rollers relative to a snapping gap; and

FIG. 3 presents a longitudinal sectional view of snapping rollers constructed according to the invention, in the interior of each of which overload clutches are disposed.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

FIG. 1 shows a front attachment 1 for harvesting grain corn, constructed according to the invention, wherein only a subsection thereof is shown. The front in attachment 1 is coupled to a non-illustrated feed rake of self-propelled combine harvester (not shown), This feed rake is used to feed the crop, that is, corn cobs in this case, to a non-illustrated threshing mechanism of the combine harvester. In the threshing mechanism, the corn kernels are removed from the cobs during the threshing process. During the harvesting process, the front attachment 1 is operated in a direction of travel indicated by an arrow 2.

The front attachment 1 comprises an intake conveyor mechanism 3, which, in the front region thereof, has conveyor wheels 4, 4a and 5. Conveyor wheels 4 and 4a each rotate in the clockwise direction, where conveyor wheel 5 rotates in the counterclockwise direction. A guide channel 6 is formed between the conveyor wheels 4 and 5 and along the circumference of the conveyor wheel 4a, wherein this guide channel is limited by a cover 7 in the region of the conveyor wheel 4a. An end section of the guide channel 6 leads into a first snapping unit 8. The front attachment 1 can harvest the corn plants in a row-dependent manner or in a row-independent manner and therefore, wherein in the latter salsa, the corn plants are possibly not fed in an ordered manner In addition, it is assumed that more than one row of corn plants is harvested with a front attachment 1 that operates in a row-independent manner and that can be used according to FIG. 1.

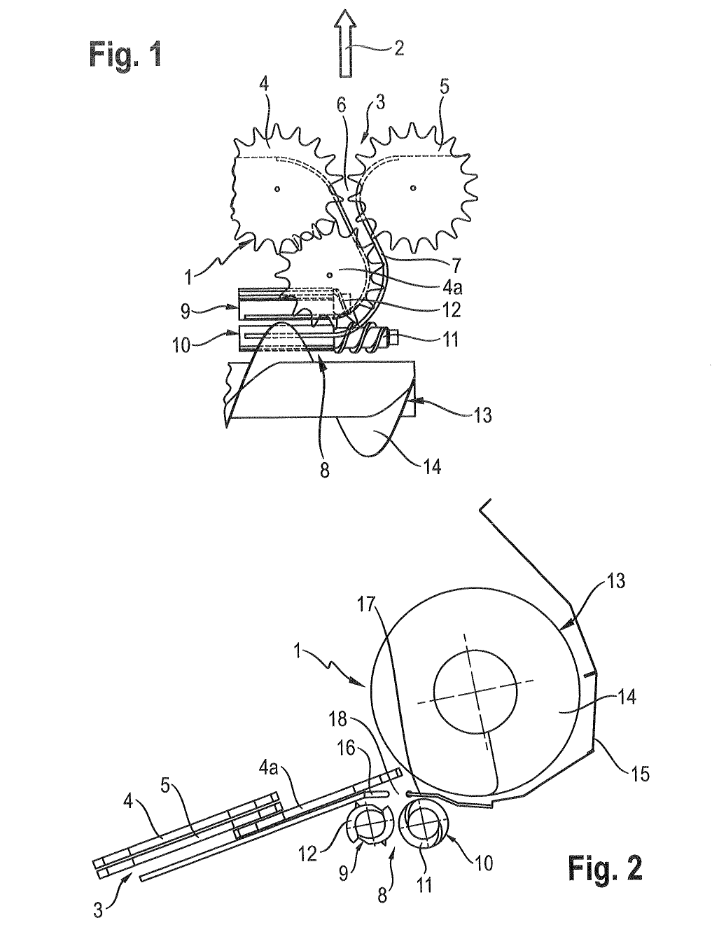

The snapping units 8 depicted in FIGS. 1 and 2 comprise snapping rollers 9 and 10, which are driven in pairs. Each pair of snapping rollers comprises an anterior snapping roller 9 and a posterior snapping roller 10, wherein each posterior snapping roller 10 is axially extended and is equipped with a header auger 11. By comparison, the particular anterior snapping rollers 9 are shorter and are therefore equipped with a relatively short header auger 12. In addition, the snapping rollers 9 and 10 are profiled on the outer circumference thereof, in order to transport the corn stalk underneath the front attachment 1 during the snapping process. From the position underneath the front attachment 1, the corn stalk is fed to a not-shown chopping mechanism or is deposited onto the field. In the latter case, a mulching device can be disposed underneath the feed rake or behind the combine harvester to fragmentize the corn stalks and the leaf portions of the corn plant in such a way that they can rot in the ground after the final soil management process.

The snapping unit 8 is adjoined by an auger-shaped cross conveyor 13, which comprises opposing auger flights (only an auger flight 14 turning to the right is shown). These auger flights, which turn to the left or the right, draw the corn cobs transported by the snapping units 8, when the cross conveyor 13 is driven, into the intake region of the cross conveyor 13 in the direction of the center of the front attachment 1. From there, the corn cobs enter the feed rake via a non-illustrated inlet opening.

FIG. 2 shows, in a schematic sectional drawing, the arrangement of the intake conveyor mechanism 3 in a front attachment 1 according to the invention. The cross conveyor 13 is disposed in a header trough 15 in this case. It is clear that the snapping unit 8 is disposed, with the anterior and posterior snapping rollers 9 and 10 thereof, respectively, substantially within an extension of the cross conveyor 13. An anterior snapping plate 16 and a posterior snapping plate 17 are located above these snapping rollers 9 and 10, wherein these snapping plates 16 and 17 delimit a snapping gap 18, by way of which the corn stalks are drawn in between the snapping rollers 9 and 10. The corn cob or corn cobs are thus separated from the corn stalk via the corresponding snapping plates 16 and 17, wherein the corn stalk is drawn downward. The cross conveyor 13 also may be disposed offset toward the rear relative to the posterior snapping roller 10, in the direction of the feed rake. This posterior snapping roller is therefore located outside of the extension of the cross conveyor 13.

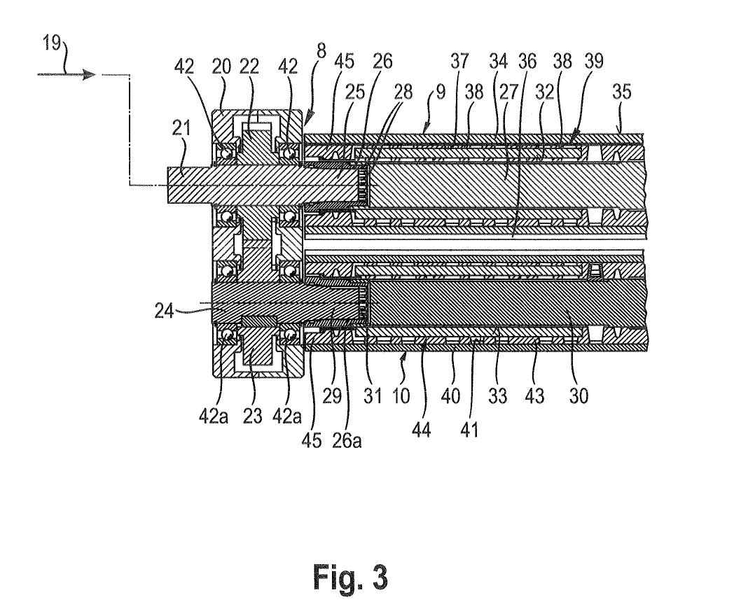

The drive of the two snapping rollers 9 and 10 is shown in a longitudinal sectional view in FIG. 3. An arrow 19 indicates that an input shaft 21, which is supported in a gearbox housing 20 by a roller bearing 42, is driven by a main drive system of the combine harvester. The input shaft 21 accommodates a drive wheel 22, which, together with a driven wheel 23, forms a wheel pair. This driven wheel 23 is disposed on a shaft stub 24, which also is supported in the gearbox housing 20 by roller bearings 42a. The input shaft 21 comprises an extension 25 which has a tapered diameter and extends into a recess 26 of a shaft 27, which accommodates the snapping roller 9. A rotationally locked connection is thereby produced between the input shaft 21 and the shaft 27, since the extension 25 and the interior of the recess 26 are equipped with a toothed structure 28. According to an alternative embodiment, the input shaft 21 and the shaft 27 accommodating the snapping roller 9 are designed as a common shaft, which is supported in the gearbox housing 20 in a floating manner by the roller bearing 42.

The shaft stub 24 disposed in the driven wheel 22 has a similar design, because this shaft stub also has an extension 29 having a reduced diameter and which is disposed in a recess 26a of a shaft 30 assigned to the snapping roller 10 and is connected thereto by a toothed structure 31. Each of the shafts 27 and 30 has an outer jacket surface 32 and 33, respectively. In addition, the snapping roller 9 comprises a hollow cylindrical roller body 34, the outer jacket 35 of which is profiled, i.e., comprises ribs 36 extending in the longitudinal direction.

Coupling elements 38 of a first overload clutch 39 are disposed between an inner jacket surface 37 of the roller body 34 and the outer jacket surface 32 of the shaft 27. The second snapping roller 10 also comprises a hollow cylindrical roller body 40, which is externally profiled. An inner jacket surface 41 of this roller body 40, together with the outer jacket surface 33 of the shaft 30 and, with coupling elements 43, forms an overload clutch 44 assigned to this snapping roller 10. The snapping rollers 9 and 10 are shortened in the depiction, and therefore corresponding header augers are not shown. Furthermore, the roller bodies 34 and 40 are guided on the shafts 27 and 30, respectively, via sliding bearing elements 45.

FIG. 3 shows overload clutches 39 and 44 directly assigned to the two snapping rollers 9 and 10, which are advantageously integrated into the snapping rollers 9 and 10. FIGS. 1 and 2 show a specific embodiment of an intake conveyor mechanism 3 and a position of the snapping rollers 9 and 10 transversely to the harvesting direction. The snapping rollers 9 and 10 provided with overload clutches 39 and 44, respectively, also can be disposed in the longitudinal direction, i.e., in the harvesting direction of the combine harvesters and can be combined with any type of intake conveyor mechanism

### LIST OF REFERENCE CHARACTERS

1 front attachment

2 arrow for direction of travel

3 intake conveyor mechanism

4 conveyor wheel

4a conveyor wheel

5 conveyor wheel

6 guide channel

7 cover

8 snapping unit

9 picking roller

10 snapping roller

11 header auger of 10

12 header auger of 9

13 cross conveyor

14 auger flight

15 header trough

16 anterior snapping plate

17 posterior snapping plate

18 snapping gap

19 arrow for main drive

20 gearbox housing

21 input shaft

22 drive wheel

23 driven wheel

24 shaft stub

25 extension of 21

26 recess of 27

26a recess of 30

27 shaft

28 tooth structure

29 extension

30 shaft

31 tooth structure

32 outer jacket surface of 27

33 outer jacket surface of 30

34 roller body of 9

35 outer jacket

36 ribs of the profiling

37 inner jacket surface of 34

38 coupling elements

39 overload clutch

40 roller body of 10

41 inner jacket surface of 40

42 roller bearing

42a roller bearing

43 coupling elements

44 overload clutch

45 sliding bearing elements

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A front attachment for harvesting corn for a self-propelled harvesting machine comprises a snapping unit for processing corn plants and separating corn cobs from non-corn-cob components Of the corn plants, the snapping unit comprising:
a drive train;
a pair of snapping rollers arranged to rotate in opposite directions; and
overload clutches disposed within the drive train of the snapping unit, wherein one each of the overload clutches is directly assigned to one each of the snapping rollers.

2. The front attachment according to claim 1, wherein each of the overload clutches is disposed within a respective shaft accommodating each of the snapping rollers.

3. The front attachment according to claim 1, wherein each of the overload clutches is disposed within an axial extension of each of the snapping rollers.

4. The front attachment according to claim 3, wherein the snapping rollers comprise a hollow cylindrical roller body, wherein the overload clutches are formed by first coupling surfaces formed on an inner jacket surface of the roller body, by second coupling surfaces formed on an outer jacket surface of a shaft, which extends concentrically through the roller body and by coupling elements disposed between the inner jacket surfaces and the outer jacket surfaces.

5. The front attachment according to claim 4, wherein the inner jacket surface is guided with frictional engagement relative to the outer jacket surface.

6. The front attachment according to claim 4, wherein the inner jacket surface, the outer jacket surface, or both, together with the coupling elements, form a coupling system acting with non-positive and positive engagement.

7. The front attachment according to claim 6, wherein detent grooves are formed on the inner jacket surface, the outer jacket surface or both, into which coupling elements designed as blocking elements engage.
